(19) United States
(12) Patent Application Publication
(10) Pub. No.: US 2006/0054641 A1
(43) Pub. Date: Mar. 16, 2006

(54) Compression of containers

(75) Inventor: Lucas Alphonsus Maria Evers, Zeist (NL)

Correspondence Address: BROWDY AND NEIMARK, P.L.L.C.;624 NINTH STREET, NW, SUITE 300, WASHINGTON, DC, 20001-5303, US

(73) Assignee: Well Design B.V., HW Utrecht (NL)

(21) Appl. No.: 10/512,576

(22) PCT Filed: Apr. 25, 2003
(86) PCT No.: PCT/NL03/00311

§ 371 Date: Oct. 26, 2004

(30) Foreign Application Priority Data
Apr. 26, 2002 (NL) 1020492

(51) Int. Cl. B65D 88/54; G01F 11/06; G01F 11/30; G01F 11/36; G01F 11/42

(52) U.S. Cl. 222/326

(57) ABSTRACT

A system for dispensing a substance comprises an axially compressible container (2) for holding a stock of substance. The container has a tubular, dimensionally stable wall which, at one end has a dispensing part (6) with a dispensing passage (7) and at the other end has a closed end (10) which is integral with the wall. The system comprises a device (1) for the metered dispensing of the substance. The device comprises a support (3) with a retaining member (9) for the dispensing part of the container. The device comprises a pressured-exerting member (11) which can be displaced in the axial direction and has a pressure-exerting side (12) which is designed to act on the closed end of the container. The device has drive means for the pressure-exerting member. Substance is dispensed by axial compression of the container under the influence of axial displacement of the pressure-exerting member in the pressure direction. Furthermore, the system has a valve (8) for opening the closing dispensing passage of the container.

The invention relates to the compression of containers with a dimensionally stable wall, such as for example PET bottles, metal tubes, plastic tubes, aluminium cans or containers made from plastic-coated paperboard.

The prior art has disclosed devices with which containers of this type, such as for example PET bottles, are compressed when they are empty before then being disposed of. These devices are aimed at limiting the space taken up by the empty container when it is to be disposed of.

It is an object of the invention to provide a system which allows substance to be dispensed through axial compression of the container.

This object is achieved by a system for dispensing a substance, comprising an axially compressible container for holding a stock of substance, which container has a tubular, dimensionally stable wall, which at one end has a dispensing part with a dispensing passage and at the other end has a closed end which is integral with the wall, and comprising a device for the metered dispensing of the substance, which device comprises:
a support for the container, which support forms an axial bore which is delimited by a supporting wall of the container and into which the container fits, and which support is provided with a retaining member for the dispensing part of the container,
a pressure-exerting member which can be displaced in the axial direction and has a pressure-exerting side which is designed to act on the closed end of the container, and
drive means for the pressure-exerting member, in such a manner that the dispensing of substance from the container takes place by axial compression of the container under influence of axial displacement of the pressure-exerting member in the direction of the retaining member for the dispensing part of the container, the system comprising a valve for opening and closing the dispensing passage of the container.

The invention also relates to a compressible container according to claim 24.

Furthermore, the invention relates to a device and a method for dispensing a substance according to claims 23 and 25, respectively.

Further preferred embodiments and advantages of the invention will emerge in the following description of figures with reference to the drawing, in which:

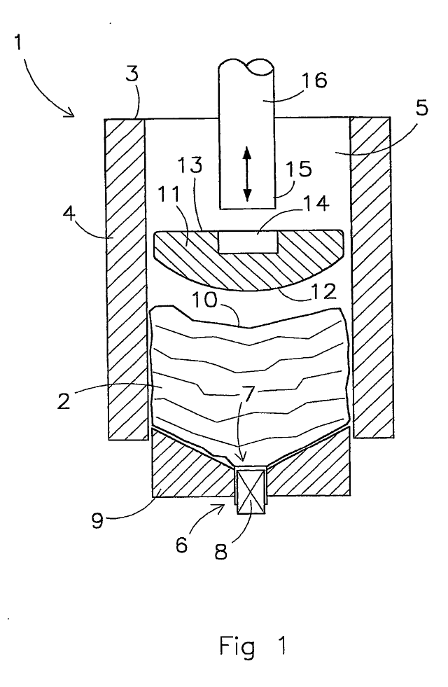

FIG. 1 diagrammatically depicts a system according to the invention,

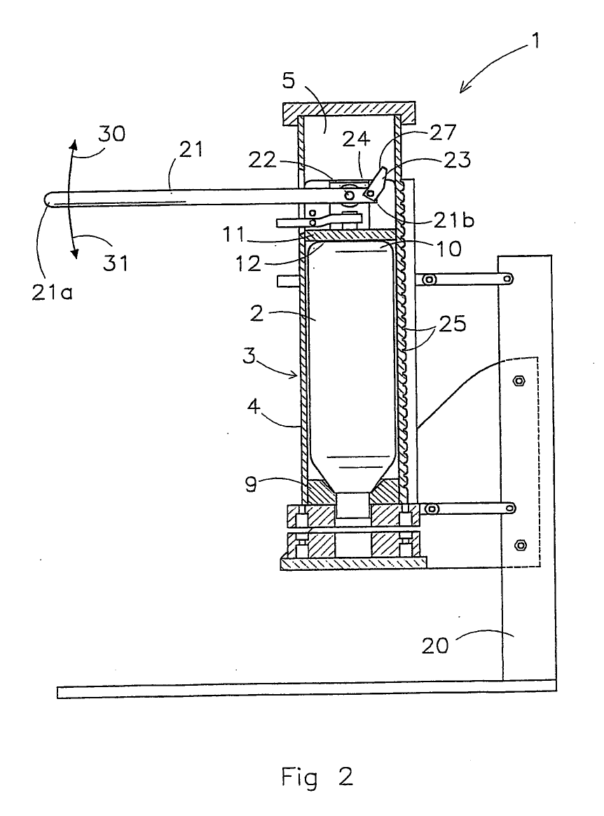

FIG. 2 shows a preferred embodiment of the system according to the invention,

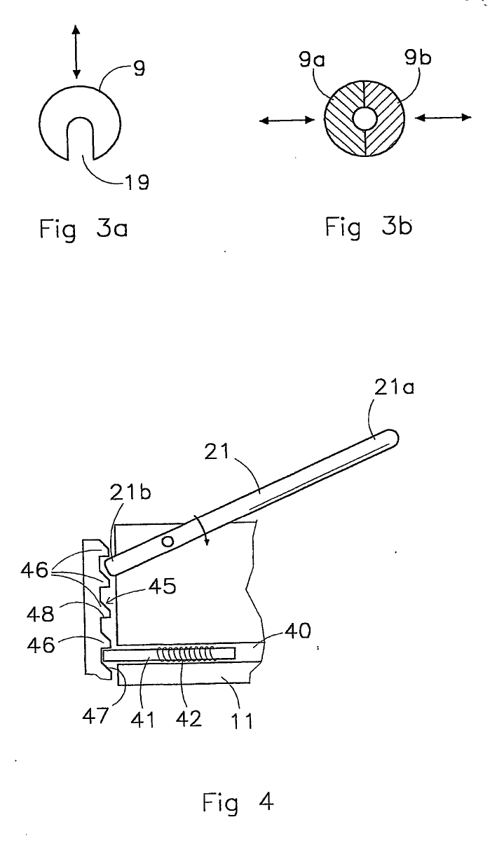

FIGS. 3a and 3b show two possible embodiments of a retaining member of a device for the system according to the invention, and

FIG. 4 shows an embodiment of drive means for a pressure-exerting member of a device for the system according to the invention.

FIG. 1 shows a device 1 with a container 2 inside it. In FIG. 1, the container 2 is illustrated as a partially compressed bottle.

The bottle comprises a tubular, dimensionally stable wall and at one end has a dispensing part 6. The dispensing part 6 of the bottle has a dispensing passage 7 which is closed off by an actuable valve 8. At the other end, the container 2 has a closed end 10.

The valve 8 can be actuated in one way or another by suitable means. The valve 8 prevents air and dirt from penetrating into the dispensing passage 7, with the advantage that the quality of the substance is retained, so that the substance is held in and can be dispensed from the container 2 in a hygienic way.

The device 1 comprises a support 3 for the container 2. The support 3 forms an axial bore 5 which is delimited by a supporting wall 4, which in this example is cylindrical. Furthermore, the support 3 is provided with a retaining member 9 which retains the dispensing part 6 in the axial direction.

The device 1 has a pressure-exerting member 11 which can move in the axial bore 5. In the embodiment shown, the pressure-exerting member 11 has a cross section which is complementary to the bore 5, but this is not imperative. Furthermore, the pressure-exerting member 11 has a pressure-exerting side 12 which is suitable for acting on the closed end 10 of the container 2. Furthermore, the pressure-exerting member 11 may be formed in such a manner that, optionally by interacting with the retaining member, it ensures that the closed end 10 and the dispensing part 6 of the container 2 are deformed in such a manner that the container 2 is emptied in an optimum way and no substance remains behind in the container 2. In the embodiment shown, the top side 13 of the pressure-exerting member 11, located on the opposite side from the pressure-exerting side 12, is provided with a recess 14 in which one end 15 of a ram 16 can be received. The ram 16 can be moved in a reciprocating manner and forms part of drive means (not shown in more detail) of the pressure-exerting member 11. When the ram 16 moves in the direction of the retaining member 9, the end 15 of the ram 16 is received in the recess 14 and the container 2 is compressed, so that substance is dispensed at the dispensing passage 7. In another embodiment, the ram 13 may also be fixedly connected to the pressure-exerting member 11. It is also conceivable for the pressure-exerting member 11 to be driven by other means, such as for example pneumatic means.

The containers may contain various substances, such as for example soups, sauces, olive oil and other foodstuffs as well as substances which are not classified as foodstuffs. In some cases, it may be advantageous for the device 1 to be provided with heating and/or cooling means. For example, it is possible for the supporting wall 4 to be heated or cooled, so that the contents of the container 2 are kept at a specific, desired temperature. Cooling of the substance may be desirable when dispensing foodstuffs such as, for example, sauces, so that their shelf life is extended. Heating may be necessary in order to enable foodstuffs to be processed further at the correct temperature immediately. In this respect, consideration may be given to soups which can be consumed immediately after they have been dispensed from the container 2.

Furthermore, the device may be provided with a quick-change system (not shown) in which a plurality of containers are held and, at the same time, cooled or heated by cooling and/or heating means. If a container containing, for example, soup is empty, it can immediately be exchanged, by means of the quick-change system, for another, full container, from which the soup can be dispensed at the correct temperature immediately.

In this case, the retaining member 9 is designed as a stop block which serves as a stop for the dispensing part 6 of the container 2. FIG. 3a shows a plan view of a possible embodiment, in which the dispensing passage 7 is received in a slot-like recess 19 in the stop block and this stop block can be displaced laterally with respect to the supporting wall 4 in order to enable the container 2 to be removed from the support 3 on the stop side. In another possible embodiment, as shown in FIG. 3b, the stop block comprises two sections 9a and 9b, which can be moved away from one another, so that the path is cleared for the container 2 to be removed from the support 3. It will be clear that embodiments of the retaining member 9 other than those shown here, which can be moved out of the path of the container 2, are possible. Furthermore, the retaining member is preferably designed in such a way that the container can be deformed in such a manner that it can be pressed completely empty, with the advantage that there is minimal spillage of substance which is to be dispensed.

FIG. 2 shows a preferred embodiment of a device 1 according to the invention, in which identical components are denoted by the same reference symbols as those used above. The device 1 comprises a frame 20 to which the support 3 is secured.

The device 1 has a pressure-exerting member 11 which can move in the axial bore 5. In this preferred embodiment, the pressure-exerting member 11 has a cross section which is complementary with respect to the bore 5. Furthermore, the pressure-exerting member 11 has a pressure-exerting side 12 which is suitable for acting on the closed end 10 of the container 2. On the other side of the pressure-exerting member 11, a lever 21 is pivotably connected to the pressure-exerting member 11 at 22. The lever 21 has an end 21a at which the lever 21 can be actuated, for example by hand. It is also possible for the lever to be actuated in other ways. At the other end 21b of the lever 21, a locking member 23 is pivotably connected to the lever 21 at 24.

On one side in the axial direction, the supporting wall 4 is provided with toothing 25. The locking member 23 has a position as shown in FIG. 2, in which an inclined side 26 moves past the toothing 25 in the direction of the retaining member 9 when the end 21a of the lever 21 is moved upwards, as indicated by the arrow 30. In this case, the locking member 23 runs clear of the toothing. If the end 21a of the lever 21b is then moved downwards, in the direction indicated by arrow 31, that end of the locking member 23 which faces the toothing will engage behind one of the teeth of the toothing 25 and will tilt with respect to the lever 21 about the point 24 until the side 27 which is located on the opposite side from the inclined side 26 lies in line with the lever 21. In this second position, further rotation of the locking member 23 with respect to the lever 21 in this direction is blocked. At that moment, the toothing 25 forms a stop and the toothing 25 exerts a reactive force on the locking member 23. A resultant force on the pressure-exerting member 11 in the direction of the retaining member 9 is the result of this reactive force on the locking member 23 and of the force exerting on the end 21a of the lever 21, with the result that the pressure-exerting member 10 is moved in the pressure direction, i.e. towards the retaining member 9. Furthermore, in the second position the locking member 23 serves as a securing member for blocking movement of the pressure-exerting member 11 in the opposite direction to the pressure direction.

In the embodiment shown in FIG. 2, the drive means comprise a lever structure. It should be understood that a drive of this type can be replaced, without departing from the scope of the invention, by any other suitable drive, which can be actuated manually, electrically, pneumatically, hydraulically or in some other way, in order to enable the pressure-exerting member 11 to execute a pressure-exerting movement, so that the substance being dispensed is metered accurately.

Furthermore, in the embodiment shown in FIG. 2, the toothing 25 is arranged on the supporting wall 4. However, it is also conceivable for the toothing to be arranged on the frame 20.

FIG. 4 shows an alternative embodiment, in which the end 21b of the lever 21 acts on the toothing 45. If the lever 21 is actuated at the end 21a, the result is a reactive force on the end 21b, with the result that a resultant force is generated, pressing the pressure-exerting member 11 downwards.

In the pressure-exerting member 11 there is a bore 40 in which there is a pin 41, which is pushed into engagement with the toothing 45 by a spring 42 in order to secure the pressure-exerting member with respect to the toothing. The teeth 46 of the toothing have an inclined side 47, with the result that the pin 41 can move along the toothing 45 in the pressure direction. In the opposite direction, the movement of the pressure-exerting member 11 is blocked as a result of the pin engaging beneath a straight side 48, located in each case on the opposite side from the inclined side 47, of the teeth.

Containers of various forms made from various materials can be used as container 2. It is advantageous to use containers which are in widespread use, inexpensive and can be produced in large numbers. For example, it is expedient to use PET bottles in a system comprising the container and the device described above, since such containers are already widely available in various shapes and dimensions for other applications, such as for holding beverages. It is also possible to use plastic-coated paperboard packaging means which are used to hold fruit juices or milk in a system as described above. Another option is to use tubes, for example made from metal, in a system as described above. Yet another option is to use can packaging means, such as for example tins.

It is known from the prior art to provide PET bottles with successive corrugations in the axial direction in order to facilitate deformation of the container under the influence of a compressive force and to increase the rigidity of the filled bottle. For example, it is possible for a person, albeit with a reasonable amount of force, to manually compress an empty PET bottle provided with corrugations before disposing of it. These corrugations are also advantageous in the containers for novel use in the abovementioned system. For example, it is therefore possible for PET bottles, but also, for example, paperboard packaging means or tubes to be provided with the above mentioned corrugations in order to facilitate compression and to increase rigidity of the filled containers.

The containers preferably have a volume of at least half a litre.

1-25. (canceled)

26. System for dispensing a substance, comprising an axially compressible container for holding a stock of substance, which container has a tubular, dimensionally stable wall, which at one end has a dispensing part with a dispensing passage and at the other end has a closed end which is integral with the wall, and comprising a device for the metered dispensing of the substance, which device comprises:
a support for the container, which support forms an axial bore which is delimited by a supporting wall of the container and into which the container fits, and which support is provided with a retaining member for the dispensing part of the container,
a pressure-exerting member which can be displaced in the axial direction and has a pressure-exerting side which is designed to act on the closed end of the container, and
drive means for the pressure-exerting member, in such a manner that the dispensing of substance from the container takes place by axial compression of the container under influence of axial displacement of the pressure-exerting member in the direction of the retaining member for the dispensing part of the container,
the system comprising a valve for opening and closing the dispensing passage of the container.

27. System according to claim 26, in which the pressure-exerting member is designed to deform the closed end and/or, in cooperation with the retaining member, the dispensing part of the container.

28. System according to claim 26, in which the device is provided with means for keeping the substance at the correct temperature.

29. System according to claim 26, in which the supporting wall is substantially cylindrical, and the pressure-exerting member has a complementary cross section.

30. System according to claim 26, in which the retaining member for the container is formed by one or more stops, which project inwards with respect to the supporting wall, for the dispensing part of the container.

31. System according to claim 30, in which the one or more stops are designed such that they can be moved out of the path of the container, so that the container can be removed from the support on the side of the stops.

32. System according to claim 26, in which the valve is arranged at the dispensing part of the container, in order to close off the dispensing passage.

33. System according to claim 32, in which the valve comprises a stationary part which is connected, for example via a screwthread connection, to the container and is provided with an actuable valve.

34. System according to claim 26, in which the drive means for the pressure-exerting member comprise a lever, which lever is rotatably connected to the pressure-exerting member and, at a first end, interacts with means which are present on the device for creating a force in the direction of pressure on the first end, such as for example toothing, in such a manner that when, during use, the other end of the lever is actuated in the direction corresponding to the pressure direction, the pressure-exerting member is moved in the pressure direction.

35. System according to claim 34, in which the drive means are provided with a locking member which, at one end, can engage on the toothing and, at the other end, is mounted rotatably on the lever in such a manner that the locking member can adopt a first position with respect to the lever, in which the locking member can move along the toothing, and a second position with respect to the lever, in which the locking member engages on the toothing, the rotary movement of the locking member with respect to the lever being blocked in at least one direction in the second position.

36. System according to claim 26, in which the device is provided with securing means for blocking a movement of the pressure-exerting member in a direction opposite to the pressure direction.

37. System according to claim 35, in which the device is provided with securing means for blocking a movement of the pressure-exerting member in a direction opposite to the pressure direction, wherein the locking member is also used as the securing means.

38. System according to claim 36 or 37, in which the securing means comprise a spring-actuated pin.

39. System according claim 26, in which the wall of the container is provided with a pattern of corrugations which follow one another in the axial direction, in order to facilitate deformation of the container under the influence of the compressive force and to strengthen the filled container.

40. System according to claim 26, in which the container is designed as a plastic bottle, for example a PET bottle.

41. System according to claim 26, in which the container is made from plastic-coated paperboard.

42. System according to claim 26, in which the container is designed as a tube.

44. System according to claim 42, in which the tube is made from plastic.

45. System according to claim 26, in which the container is made from tin plate.

46. System according to claim 26, in which the container is designed as an aluminium can.

47. System according to claim 26, in which the container has a volume of at least half a litre.

48. Device for the metered dispensing of the substance from an axially compressible container for holding a stock of substance, which device comprises:
a support for the container, which support forms an axial bore which is delimited by a supporting wall of the container and into which the container fits, and which support is provided with a retaining member for a dispensing part of the container,
a pressure-exerting member which can be displaced in the axial direction and has a pressure-exerting side which is designed to act on a closed end of the container, and
drive means for the pressure-exerting member, in such a manner that the dispensing of substance from the container takes place by axial compression of the container under influence of axial displacement of the pressure-exerting member in the direction of the retaining member for the dispensing part of the container.

49. An axially compressible container for holding a stock of substance, which container has a tubular, dimensionally stable wall, which at one end has a dispensing part with a dispensing passage and at the other end has a closed end which is integral with the wall, wherein a valve is arranged at the dispensing part of the container, in order to close off the dispensing passage.

50. Method for dispensing a substance using a system comprising an axially compressible container for holding a stock of substance, which container has a tubular, dimensionally stable wall, which at one end has a dispensing part with a dispensing passage and at the other end has a closed end which is integral with the wall, and comprising a device for the metered dispensing of the substance, which device comprises:
a support for the container, which support forms an axial bore which is delimited by a supporting wall of the container and into which the container fits, and which support is provided with a retaining member for the dispensing part of the container,
a pressure-exerting member which can be displaced in the axial direction and has a pressure-exerting side which is designed to act on the closed end of the container, and
drive means for the pressure-exerting member, in such a manner that the dispensing of substance from the container takes place by axial compression of the container under influence of axial displacement of the pressure-exerting member in the direction of the retaining member for the dispensing part of the container,
the system comprising a valve for opening and closing the dispensing passage of the container.
